(19) United States
(12) Patent Application Publication
(10) Pub. No.: US 2026/0237080 A1
(43) Pub. Date: Aug. 13, 2026

(54) OBJECT TRACKING DEVICE, OBJECT TRACKING METHOD, AND RECORDING MEDIUM

(71) Applicant: NEC Corporation, Tokyo (JP)

(72) Inventor: Yasuto NAGASE, Tokyo (JP)

(73) Assignee: NEC Corporation, Tokyo (JP)

(21) Appl. No.: 19/158,918

(22) PCT Filed: Feb. 28, 2023
(86) PCT No.: PCT/JP2023/007324

§ 371 Date: Aug. 22, 2025

(51) Int. Cl. G06T 7/20; G06T 5/80; G06V 10/74

(52) U.S. Cl. CPC G06T 7/20; G06T 5/80; G06V 10/761; G06T 2207/20021; G06T 2207/20212

(57) ABSTRACT

An image acquisition means obtains a wide-angle photographic image with wide-angle camera. A multi-viewpoint division means divides the wide-angle photographic image, correcting distortion, and generating a plurality of individual-viewpoint images. An object detection means detects an object to be tracked from the plurality of individual-viewpoint images. An identical object determination means limits a number of identical objects redundantly included in the detected object to be tracked to one. A designation means converts a coordinate of the object to be tracked in a coordinate system of the individual-viewpoint images into a coordinate in a coordinate system of the wide-angle photographic image, and designating the converted coordinate as a position of the object to be tracked in the wide-angle photographic image. An object tracking means tracks the object to be tracked based on the wide-angle photographic image and the designated position of the object to be tracked.

### TECHNICAL FIELD

The present disclosure relates to a technique for tracking an object in video.

### BACKGROUND ART

In recent years, 360-degree cameras have become available at low cost. Since the 360-degree cameras are capable of imaging a wide range, the number of cameras may be reduced, and their use in video analysis is being considered. Patent Document 1 discloses a technique of detecting an object from an omnidirectional image.

### PRECEDING TECHNICAL REFERENCES

### Patent Document

Patent Document 1: Japanese Laid-open Patent Publication No. 2013-183176

### SUMMARY

### Problem to be Solved by the Invention

360-degree images have large distortion, and it is difficult to directly apply existing techniques of object detection and object tracking. In order to enable detection and tracking of an object from 360-degree images, training using a dedicated data set using 360-degree images needs to be performed.

An object of the present disclosure is to enable tracking of an object from an image with distortion, such as a 360-degree image, without the need for training using a dedicated data set.

### Means for Solving the Problem

According to an example aspect of the present disclosure, there is provided an object tracking device including:
an image acquisition means configured to obtain a wide-angle photographic image with a wide-angle camera;
a multi-viewpoint division means configured to divide the wide-angle photographic image, correcting distortion, and generating a plurality of individual-viewpoint images;
an object detection means configured to detect an object to be tracked from the plurality of individual-viewpoint images;
an identical object determination means configured to limit a number of identical objects redundantly included in the detected object to be tracked to one;
a designation means configured to convert a coordinate of the object to be tracked in a coordinate system of the individual-viewpoint images into a coordinate in a coordinate system of the wide-angle photographic image, and designating the converted coordinate as a position of the object to be tracked in the wide-angle photographic image; and
an object tracking means configured to track the object to be tracked based on the wide-angle photographic image and the designated position of the object to be tracked.

According to another example aspect of the present disclosure, there is provided an object tracking method to be executed by a computer, the method including:
obtaining a wide-angle photographic image with a wide-angle camera;
generating a plurality of individual-viewpoint images by dividing the wide-angle photographic image and correcting distortion;
detecting an object to be tracked from the plurality of individual-viewpoint images;
limiting a number of identical objects redundantly included in the detected object to be tracked to one;
converting a coordinate of the object to be tracked in a coordinate system of the individual-viewpoint images into a coordinate in a coordinate system of the wide-angle photographic image, and designating the converted coordinate as a position of the object to be tracked in the wide-angle photographic image; and
tracking the object to be tracked based on the wide-angle photographic image and the designated position of the object to be tracked.

According to a further example aspect of the present disclosure, there is provided a recording medium storing a program, the program causing a computer to perform a process including:
obtaining a wide-angle photographic image with a wide-angle camera;
generating a plurality of individual-viewpoint images by dividing the wide-angle photographic image and correcting distortion;
detecting an object to be tracked from the plurality of individual-viewpoint images;
limiting a number of identical objects redundantly included in the detected object to be tracked to one;
converting a coordinate of the object to be tracked in a coordinate system of the individual-viewpoint images into a coordinate in a coordinate system of the wide-angle photographic image, and designating the converted coordinate as a position of the object to be tracked in the wide-angle photographic image; and
tracking the object to be tracked based on the wide-angle photographic image and the designated position of the object to be tracked.

### BRIEF DESCRIPTION OF THE DRAWINGS

FIG. 1 illustrates a concept of an object tracking device according to a first example embodiment.

FIG. 2 is a block diagram illustrating a hardware configuration of the object tracking device.

FIG. 3 is a block diagram illustrating a functional configuration of the object tracking device.

FIG. 4 is a diagram for explaining processing on a 360-degree image.

FIG. 5 is a diagram for explaining object detection by an object detection unit.

FIG. 6 is a diagram for explaining selection of an object by an identical object determination unit.

FIG. 7 is a diagram for explaining coordinate transformation by a tracked object designation unit.

FIG. 8 is a diagram for explaining correction by a distortion correction unit.

FIG. 9 is a flowchart of an object tracking process.

FIG. 10 is a diagram for explaining angles of individual-viewpoint images as parameters for multi-viewpoint division.

FIG. 11 illustrates a configuration at a time of changing a method of multi-viewpoint division based on an object detection result.

FIG. 12 illustrates a configuration at a time of changing the method of multi-viewpoint division based on a tracking result.

FIG. 13 illustrates an exemplary synthetic image of individual-viewpoint images.

FIG. 14 is a diagram for explaining a method of determining an identical object using coordinate transformation.

FIG. 15 is a block diagram illustrating a configuration of an object tracking device according to a second example embodiment.

FIG. 16 is a flowchart illustrating a process of the object tracking device according to the second example embodiment.

### EXAMPLE EMBODIMENTS

Hereinafter, preferred example embodiments of the present disclosure will be described with reference to the drawings.

### First Example Embodiment

### Overall Configuration

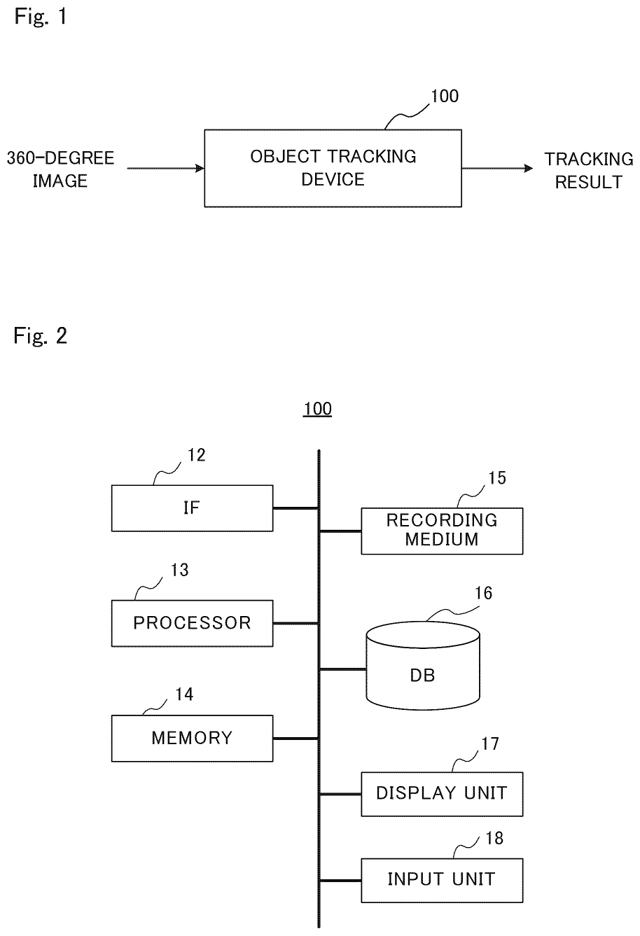

FIG. 1 illustrates a concept of an object tracking device according to a first example embodiment. An object tracking device 100 detects and tracks a predetermined object to be tracked from a 360-degree image captured by a 360-degree camera. A 360-degree image is input to the object tracking device 100. The 360-degree image is a moving image including a plurality of frame images. The object tracking device 100 detects and tracks the object to be tracked from the input 360-degree image, and outputs a tracking result. The tracking result may be, for example, time-series data of positional information of the object to be tracked in the 360-degree image, or may be a moving image in which a position of the object to be tracked is indicated by a rectangle or the like in the 360-degree image.

### Hardware Configuration

FIG. 2 is a block diagram illustrating a hardware configuration of the object tracking device 100. As illustrated, the object tracking device 100 includes an interface (IF) 12, a processor 13, a memory 14, a recording medium 15, a database

The IF 12 obtains a 360-degree image from the 360-degree camera. Note that in a case where a 360-degree image captured in advance is stored in an image database (Hereinafter, the database will be referred to as a “DB”.), the IF 12 may obtain the 360-degree image from the image DB. The IF 12 outputs the tracking result by the object tracking device 100 to an external device as appropriate.

The processor 13 is a computer such as a central processing unit (CPU), and takes overall control of the object tracking device 100 by executing a program prepared in advance. As the processor 13, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, a combination thereof, or the like may be used. The processor 13 performs an object tracking process to be described later.

The memory 14 includes a read only memory (ROM), a random access memory (RAM), or the like. The memory 14 stores various programs to be executed by the processor 13. The memory 14 is also used as a work memory during execution of various types of processing by the processor 13.

The recording medium 15 is a non-volatile and non-transitory recording medium such as a disk-shaped recording medium, a semiconductor memory, or the like, and is detachable from the object tracking device 100. The recording medium 15 records various programs to be executed by the processor 13. In a case where the object tracking device 100 executes various types of processing, a program recorded in the recording medium 15 is loaded into the memory 14, and is executed by the processor 13.

The DB 16 stores the 360-degree image input through the IF 12. The tracking result by the object tracking device 100 is also stored in the DB 16 as appropriate.

The display unit 17 includes, for example, a liquid crystal display or the like. The input unit 18 includes, for example, a keyboard, a mouse, and the like. For example, the display unit 17 and the input unit 18 are used by an operator of the object tracking device 100 to make required operation input, or to view the object tracking result.

### Functional Configuration

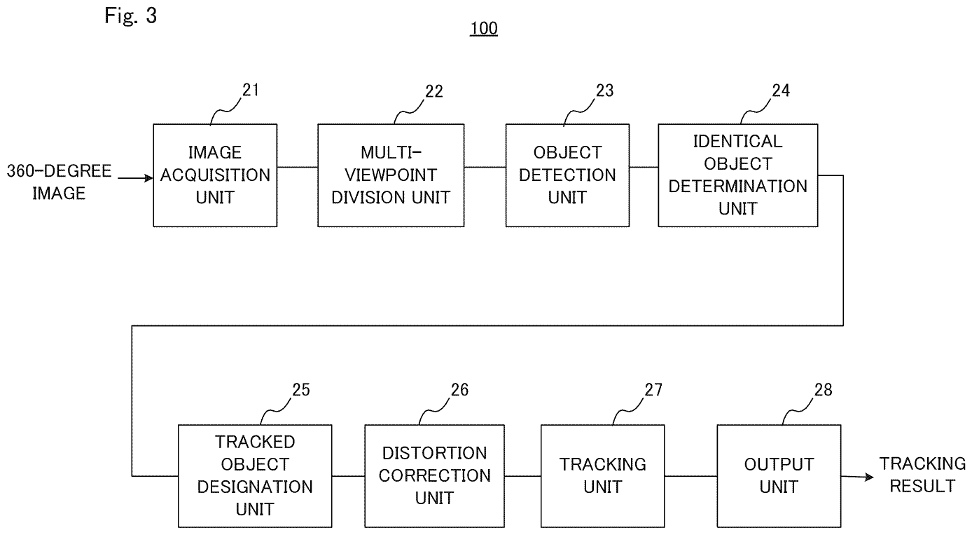

FIG. 3 is a block diagram illustrating a functional configuration of the object tracking device 100. The object tracking device 100 functionally includes an image acquisition unit 21, a multi-viewpoint division unit 22, an object detection unit 23, an identical object determination unit 24, a tracked object designation unit 25, a distortion correction unit 26, a tracking unit 27, and an output unit 28.

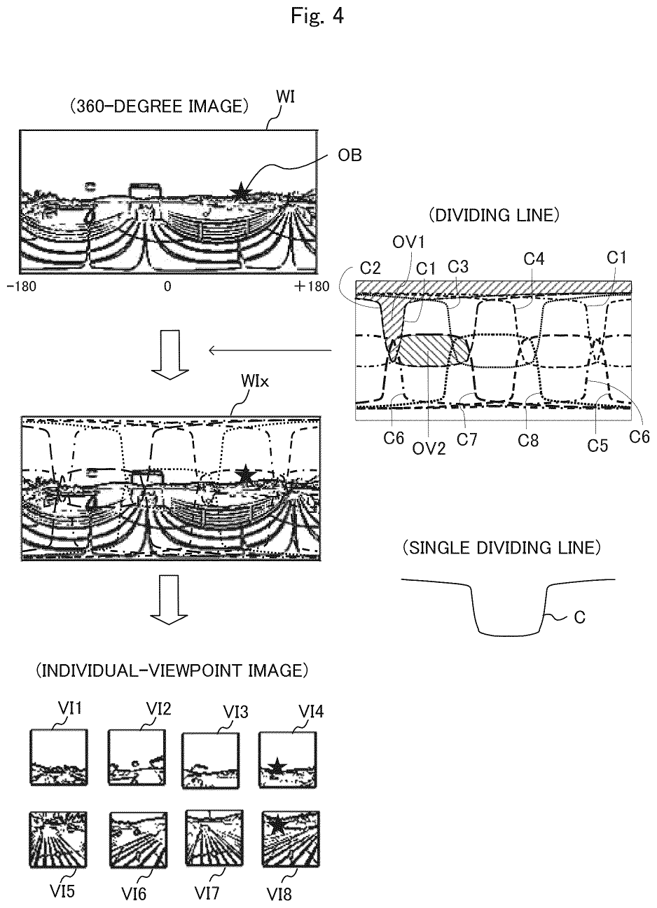

The image acquisition unit 21 obtains a 360-degree image. FIG. 4 illustrates processing on the 360-degree image. As illustrated in FIG. 4, a 360-degree image WI is an image captured by the 360-degree camera, and is an image obtained by imaging over 360 degrees (all directions) in a predetermined range in the vertical direction of a spherical surface centered on the camera position at the time of shooting. Assuming that the central direction in the 360-degree image WI is the 0-degree direction, as illustrated in the drawing, the left end of the 360-degree image WI is associated to the −180-degree direction, and the right end is associated to the +180-degree direction. That is, the left end region and the right end region of the 360-degree image WI have image content obtained by dividing a certain continuous region. The 360-degree image WI exemplified in FIG. 4 is a captured image of a lakeside, in which a pier is present in the front region of the image and an opposite shore of the lake is present in the back region of the image. In the 360-degree image WI of FIG. 4, a tracking target object OB is indicated by a star (★) for convenience. The image acquisition unit 21 outputs the obtained 360-degree image to the multi-viewpoint division unit 22.

The multi-viewpoint division unit 22 divides the input 360-degree image into individual-viewpoint images from multiple different viewpoints. In the example of FIG. 4, the multi-viewpoint division unit 22 divides the 360-degree image WI into eight individual-viewpoint images by eight dividing lines C1 to C8 illustrated in the drawing. In the example of FIG. 4, the dividing lines C1 to C4 divide the upper region of the 360-degree image WI into four viewpoints shifted by 90 degrees in the circumferential direction. The dividing lines C5 to C8 divide the lower region of the 360-degree image WI into four viewpoints shifted by 90 degrees in the circumferential direction in a similar manner. The multi-viewpoint division unit 22 further corrects distortion of each individual-viewpoint image at the time of dividing the 360-degree image into the plurality of individual-viewpoint images. As a result, the plurality of individual-viewpoint images, each of which has a different viewpoint and in which the distortion is corrected, is generated from the 360-degree image WI.

In the example of FIG. 4, the multi-viewpoint division unit 22 divides the 360-degree image WI using the dividing lines C1 to C8 as illustrated in an image WIX in the middle part on the left side, and corrects distortion of individual images. As a result, as illustrated in the lower left part of FIG. 4, individual-viewpoint images VI1 to VI8 are obtained.

At the time of dividing the 360-degree image WI into the individual-viewpoint images VI1 to VI8 as described above, multi-viewpoint division unit 22 divides the image in such a way that the adjacent regions divided by the dividing lines C1 to C8 partially overlap each other as illustrated in FIG. 4. For example, as illustrated in FIG. 4, the divided region formed by the dividing line C1 and the divided region formed by the dividing line C2 have an overlapping portion OV1 in the lateral direction of the image. The divided region formed by the dividing line C2 and the divided region formed by the dividing line C7 have an overlapping portion OV2 in the longitudinal direction of the image. The multi-viewpoint division unit 22 divides the 360-degree image in such a way that each of the individual-viewpoint images VI has a portion overlapping with another adjacent individual-viewpoint image VI.

With the overlapping portion provided in this manner, the region near the division boundary in the original 360-degree image is included in both of the two adjacent individual-viewpoint images after the division. Thus, in a case where the object to be tracked is present near the division boundary, the object is included in both of the two adjacent individual-viewpoint images, and becomes a detection target in each of the individual-viewpoint images, whereby it is highly likely that the object is correctly detected by the object detection unit 23 to be described later. In particular, since the adjacent two individual-viewpoint images are images captured from different viewpoints, the same object is included in each of the two individual-viewpoint images in different appearances. Thus, the object detection unit 23 detects the same object from images having different appearances, whereby the detection probability and the detection accuracy of the object may improve. The multi-viewpoint division unit 22 outputs the obtained individual-viewpoint images VII to VI8 to the object detection unit 23.

The object detection unit 23 detects the object to be tracked from each of the individual-viewpoint images. As described above, since each of the individual-viewpoint images is an image in which distortion is corrected, the object may be detected using an object detection model for detecting an object from a normal image. Note that the object detection unit 23 may include an existing object detection model using a neural network.

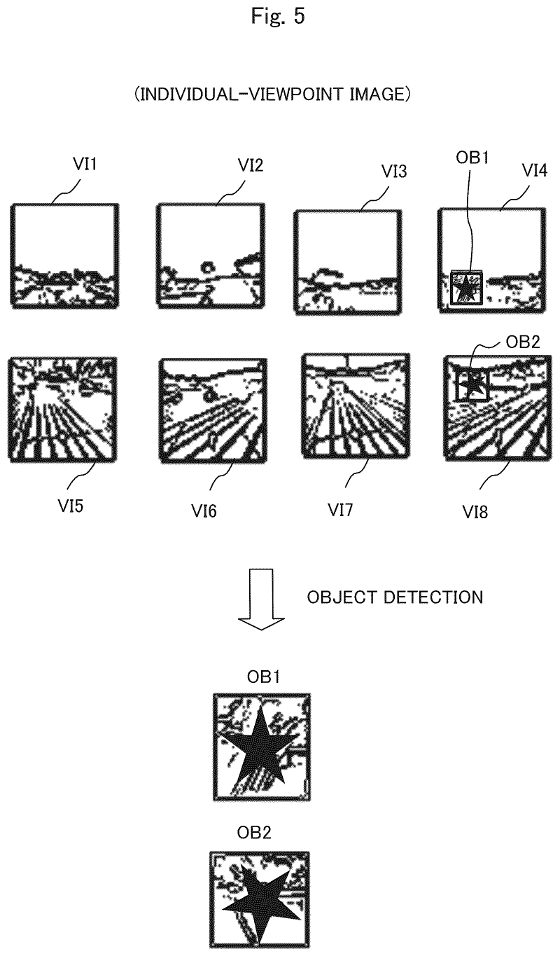

FIG. 5 is a diagram for explaining object detection by the object detection unit 23. As illustrated in FIG. 5, the tracking target object OB included in the 360-degree image WI of FIG. 4 is detected as an object OB1 from the individual-viewpoint image VI4, and is also detected as an object OB2 from the individual-viewpoint image VI8. Note that while only one object is detected from the 360-degree image WI in the examples of FIGS. 4 and 5, in a case where a plurality of objects to be tracked is included in the 360-degree image, each of them is detected by the object detection unit 23. The object detection unit 23 outputs information regarding the detected object to be tracked to the identical object determination unit 24. Note that the information regarding the object to be tracked includes, for example, positional information of a rectangle surrounding the object to be tracked, information indicating a class of the object to be tracked, and the like.

The identical object determination unit 24 first determines whether a plurality of identical objects is included in a plurality of objects detected by the object detection unit 23. In a case where there is a plurality of identical objects in the plurality of objects detected by the object detection unit 23, the identical object determination unit 24 selects one of them. That is, in a case where the identical objects are redundantly detected by the object detection unit 23, the identical object determination unit 24 limits them to one object. Note that as a simplest method, it is sufficient if the identical object determination unit 24 randomly selects one object from the plurality of objects associated to the identical tracking target. Then, the identical object determination unit 24 outputs, to the tracked object designation unit 25, one or a plurality of objects to be tracked after limiting the number of identical objects having been redundantly detected to one.

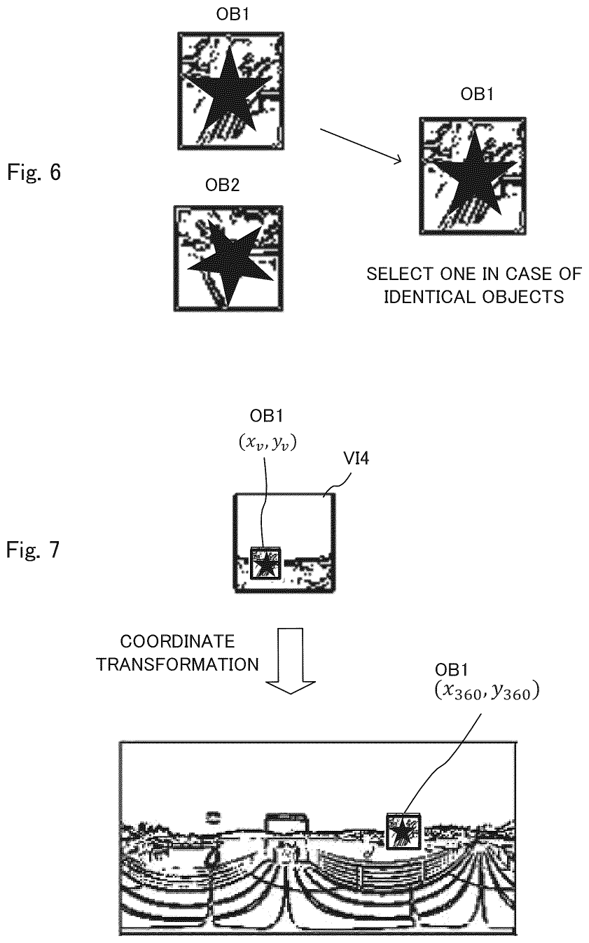

FIG. 6 is a diagram for explaining a method of selecting an object by the identical object determination unit 24. In the example of FIG. 5, two objects OB1 and OB2 are detected from the plurality of individual-viewpoint images VI1 to VI8. Thus, the identical object determination unit 24 first calculates a degree of similarity between the object OB1 and the object OB2. For example, the identical object determination unit 24 obtains feature vectors as images of the objects OB1 and OB2, and calculates a distance between the feature vectors as a degree of similarity. Then, in a case where the degree of similarity is higher than a predetermined value, the identical object determination unit 24 determines that the two objects OB1 and OB2 are identical. Then, the identical object determination unit 24 selects one of the objects OB1 and OB2, and outputs information regarding the object to the tracked object designation unit 25. In a case where the degree of similarity of the two objects is equal to or lower than the predetermined value as a result of the determination based on the degree of similarity, the identical object determination unit 24 determines that the two objects are different objects, and outputs information regarding the two objects to the tracked object designation unit 25. The object output from the identical object determination unit 24 is to be subject to tracking by the tracking unit 27 at a later stage.

The tracked object designation unit 25 performs coordinate transformation on the object output from the identical object determination unit 24. FIG. 7 is a diagram for explaining the coordinate transformation by the tracked object designation unit 25. As described above, the object detection unit 23 detects an object from the individual-viewpoint image VI, and the coordinates of the object included in the object information output from the identical object determination unit 24 are coordinates in the coordinate system of the coordinate system of the individual-viewpoint image VI. In the example of FIG. 7, the coordinates of the object OB1 output from the identical object determination unit 24 are coordinates (xv, yv) in the coordinate system of the individual-viewpoint image VI4. Thus, the tracked object designation unit 25 converts the coordinates (xv, yv) of the object OB1 in the coordinate system of the individual-viewpoint image VI4 into coordinates (x360, y360) in the coordinate system of the original 360-degree image. As a result, the object to be tracked is designated in the original 360-degree image. While the operation of designating the object to be tracked in the original 360-degree image or the like is commonly performed manually, in the present example embodiment, the coordinates of the object to be tracked detected from the individual-viewpoint image VI are subject to the coordinate transformation as described above, whereby the designation of the object to be tracked in the 360-degree image may be automated. The tracked object designation unit 25 outputs, to the distortion correction unit 26, information that represents the object to be tracked in the converted coordinates, that is, the coordinates in the coordinate system of the 360-degree image.

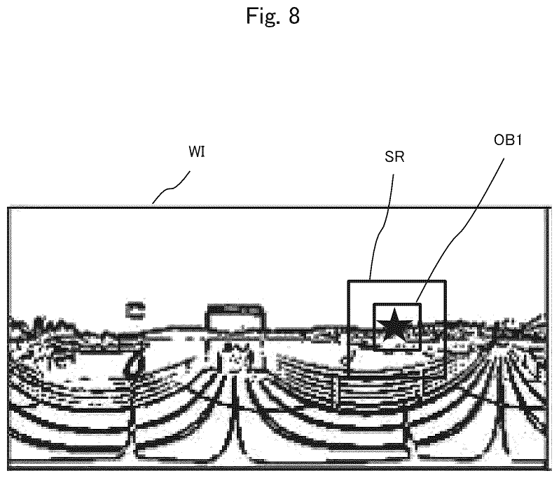

The distortion correction unit 26 corrects distortion in a predetermined range around the object to be tracked in the original 360-degree image, and outputs the corrected image to the tracking unit 27. FIG. 8 is a diagram for explaining a method of the correction by the distortion correction unit 26. In the 360-degree image WI, the distortion correction unit 26 sets, as a correction range SR, a region having a predetermined size around the tracking target object OB1 obtained from the tracked object designation unit 25, and performs distortion correction on the image of the correction range SR. As a result, an image is obtained in which the periphery of the object to be tracked in the 360-degree image has been subject to the distortion correction. The distortion correction unit 26 outputs the image after the distortion correction to the tracking unit 27.

The tracking unit 27 receives the image after the distortion correction including the object to be tracked, and tracks the object to be tracked. Since the image input to the tracking unit 27 has been subject to the distortion correction by the distortion correction unit 26, the tracking unit 27 may detect and track the object using a normal object detection model and object tracking model. In a preferred example, an object detection model and object tracking model using a neural network may be used as the tracking unit 27. The tracking unit 27 outputs a result of tracking the object to be tracked to the output unit 28.

The output unit 28 outputs the tracking result received from the tracking unit 27 to an external device or the like. The output unit 28 may store the received tracking result in the DB 16 illustrated in FIG. 2, or may display it on the display unit 17.

In the configuration described above, the image acquisition unit 21 is an exemplary image acquisition means, the multi-viewpoint division unit 22 is an exemplary multi-viewpoint division means, the object detection unit 23 is an exemplary object detection means, and the identical object determination unit 24 is an exemplary identical object determination means. The tracked object designation unit 25 is an exemplary designation means, and the tracking unit 27 is an exemplary object tracking means.

### Object Tracking Process

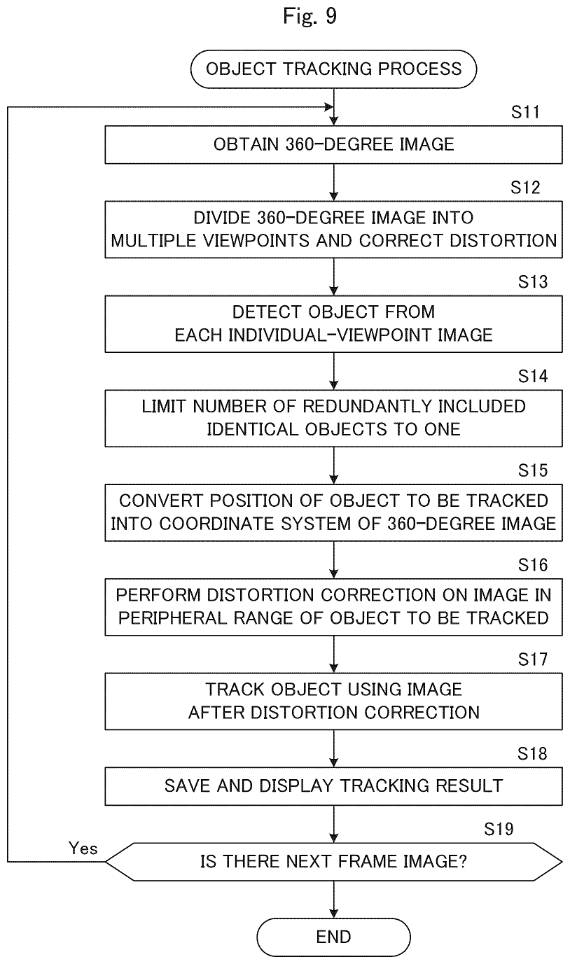

Next, the object tracking process by the object tracking device 100 will be described. FIG. 9 is a flowchart of the object tracking process. This process is achieved by the processor 13 illustrated in FIG. 2 executing a program prepared in advance and operating as each element illustrated in FIG. 3.

First, the image acquisition unit 21 obtains a 360-degree image (step S11). Next, the multi-viewpoint division unit 22 divides the 360-degree image into a plurality of individual-viewpoint images, and corrects distortion of each individual-viewpoint image (step S12). Next, the object detection unit 23 detects an object from each individual-viewpoint image (step S13). Next, in a case where the identical objects are redundantly detected among a plurality of objects detected by the object detection unit 23, the identical object determination unit 24 limits them to one object (step S14). In a case where no identical object is included in the plurality of objects detected by the object detection unit 23, the identical object determination unit 24 outputs each object as an object to be tracked.

Next, the tracked object designation unit 25 converts the coordinates of the object to be tracked in the individual-viewpoint image output from the identical object determination unit 24 into coordinates in the 360-degree image (step S15). Next, the distortion correction unit 26 performs distortion correction on the image in the peripheral range of the object to be tracked in the 360-degree image (step S16). Next, the tracking unit 27 tracks the object to be tracked using the image after the distortion correction (step S17). Then, the output unit 28 outputs a tracking result by the tracking unit 27 (step S18).

The object tracking device 100 performs the process of steps S11 to S18 described above for each frame image of the input 360-degree image. Then, the object tracking device 100 determines whether there is a next frame image (step S19). In a case where there is a next frame image (Yes in step S19), the process returns to step S11. On the other hand, if there is no next frame image (No in step S19), the object tracking device 100 terminates the process.

### Modified Example

Hereinafter, modified examples of the present example embodiment will be described. The following modified examples may be applied in appropriate combination.

### First Modified Example

While the multi-viewpoint division unit 22 divides the 360-degree image into eight individual-viewpoint images in the example embodiment described above, the dividing method by the multi-viewpoint division unit 22 may be appropriately changed according to user setting. Specifically, a user may optionally set the following parameters as parameters defining the method of dividing the 360-degree image by the multi-viewpoint division unit 22.
Number of divisions (number of individual-viewpoint images)
Overlapping rate of adjacent individual-viewpoint images
Size of individual-viewpoint image
Angle of individual-viewpoint image
Color arrangement of individual-viewpoint image
Selection of viewpoint for actual processing based on difference in appearance caused by installation location and angle of camera

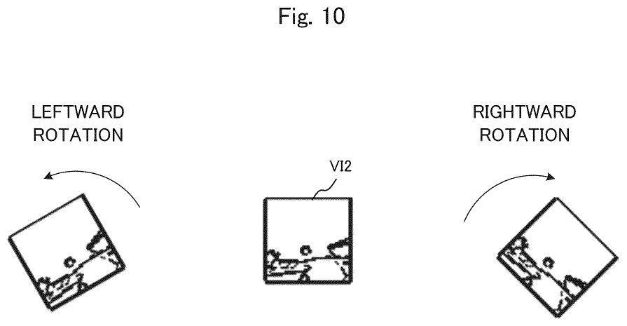

Note that the “angle of the individual-viewpoint image” includes rotating the angle of the individual-viewpoint image after the division at any angle as illustrated in FIG. 10. As described above, by rotating the angle of the individual-viewpoint image, the accuracy in detecting the object by the object detection unit 23 at a later stage may improve.

### Second Modified Example

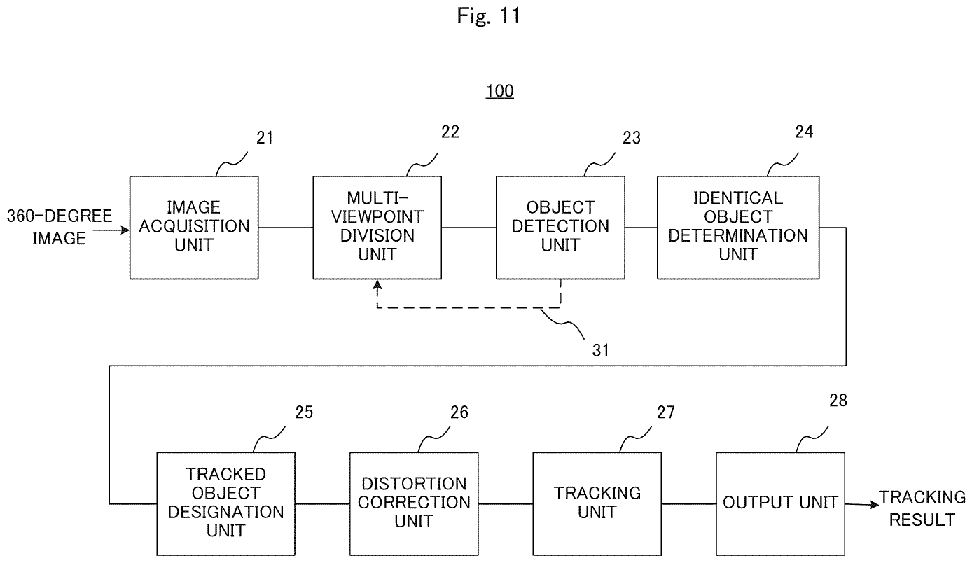

The multi-viewpoint division unit 22 may change the dividing method based on a processing result of the object tracking process at a later stage. As an example, as illustrated in FIG. 11, the multi-viewpoint division unit 22 may change the dividing method based on a result of the object detection by the object detection unit 23. In that case, the object detection unit 23 inputs information 31 regarding an object detection rate and the like to the multi-viewpoint division unit 22. For example, in a case where the number of individual-viewpoint images is too large and the object detection rate by the object detection unit 23 is low, the multi-viewpoint division unit 22 may change the dividing method to increase the object detection rate by reducing the number of individual-viewpoint images, increasing the size of the individual-viewpoint images, or the like.

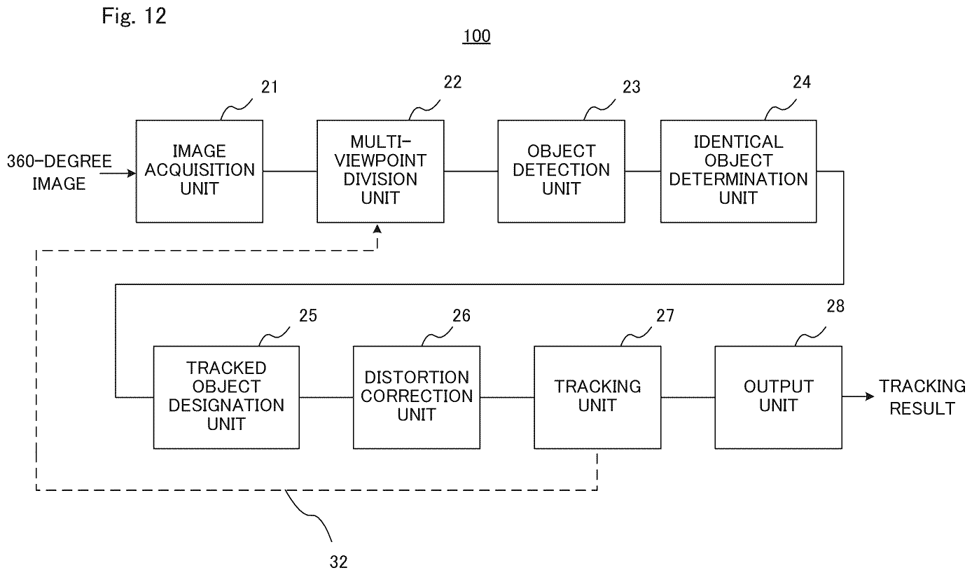

As another example, as illustrated in FIG. 12, the multi-viewpoint division unit 22 may change the dividing method based on a tracking result by the tracking unit 27. In that case, the tracking unit 27 inputs information 32 regarding a tracking success rate and the like to the multi-viewpoint division unit 22. For example, in a case where the number of individual-viewpoint images is too large and the tracking success rate by the tracking unit 27 is low, the multi-viewpoint division unit 22 may change the dividing method to increase the tracking success rate by reducing the number of individual-viewpoint images, increasing the size of the individual-viewpoint images, or the like.

### Third Modified Example

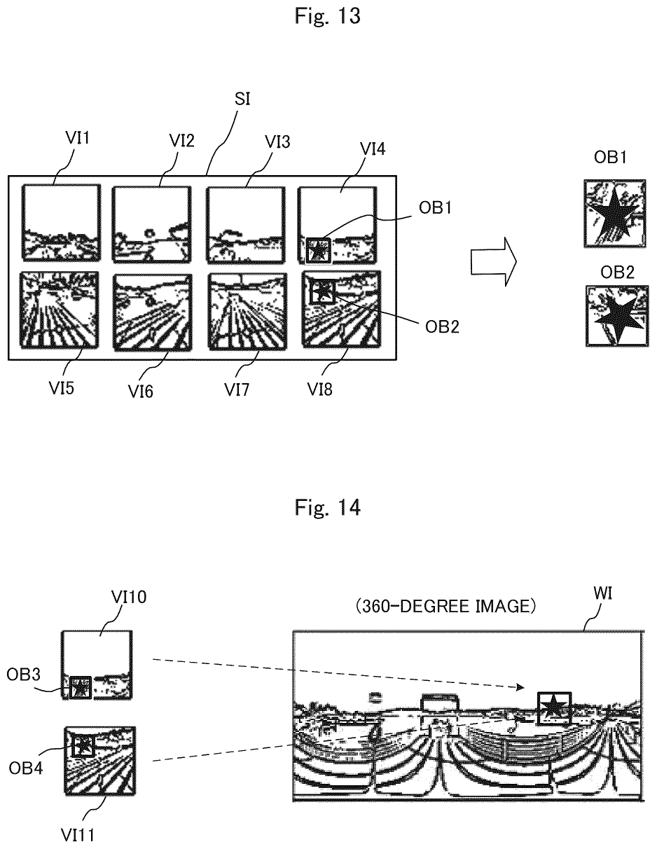

In the example embodiment described above, the object detection unit 23 detects an object from the plurality of individual-viewpoint images VI. Instead, the object detection unit 23 may combine the plurality of individual-viewpoint images VI to generate one synthetic image, and may detect the object from the synthetic image. FIG. 13 illustrates an example of the synthetic image. As illustrated in the drawing, the object detection unit 23 generates a synthetic image SI obtained by combining the individual-viewpoint images VI1 to VI8, and detects the objects OB1 and OB2 from the synthetic image SI. In this manner, by detecting the object from one synthetic image SI, the calculation cost and the calculation time for the object detection may be reduced.

### Fourth Modified Example

In the example embodiment described above, in a case where the object detection unit 23 detects a plurality of identical objects, the identical object determination unit 24 randomly selects one object therefrom. Instead, the identical object determination unit 24 may compare rectangular sizes of the plurality of detected objects, and may select an object having the largest rectangular size. The identical object determination unit 24 may compare reliability scores of the plurality of detected objects, and may select an object having the highest reliability score.

### Fifth Modified Example

In the example embodiment described above, the identical object determination unit 24 determines whether the plurality of objects is the identical object based on the degree of similarity of the objects detected by the object detection unit 23. This method is referred to as a “method of determining an identical object using a degree of similarity”. Instead, the identical object determination unit 24 may determine whether the objects are identical by converting the coordinates of each object into the coordinate system of the 360-degree image. This method is referred to as a “method of determining an identical object using coordinate transformation”.

FIG. 14 is a diagram for explaining the method of determining an identical object using coordinate transformation. As illustrated in FIG. 14, it is assumed that the object detection unit 23 detects two objects OB3 and OB4. In that case, coordinates of the objects OB3 and OB4 are represented by coordinates in the coordinate system of individual-viewpoint images VI10 and VI11. The identical object determination unit 24 converts the coordinates of the objects OB3 and OB4 in the individual-viewpoint images VI10 and VI11 into coordinates in the coordinate system of the 360-degree image WI. In a case where the objects OB3 and OB4 are the identical objects to be tracked, the coordinates of the objects OB3 and OB4 after the coordinate transformation are naturally close to each other. Thus, in a case where the positions of the objects OB3 and OB4 after the coordinate transformation are within a predetermined distance, the identical object determination unit 24 determines that the objects OB3 and OB4 are the identical objects to be tracked. On the other hand, in a case where the positions of the objects OB3 and OB4 after the coordinate transformation are not within the predetermined distance, the identical object determination unit 24 determines that the objects OB3 and OB4 are different objects to be tracked. The identical object determination unit 24 may use the method of determining an identical object using coordinate transformation described above instead of the method of determining an identical object using a degree of similarity previously described, or in combination of the method of determining an identical object using a degree of similarity.

### Sixth Modified Example

While the image input to the object tracking device 100 is a 360-degree image in the example embodiment described above, application of the present disclosure is not limited thereto. The technique according to the present disclosure is applicable to object tracking from various captured images including image distortion dependent on a lens shape or the like. Specifically, the technique according to the present disclosure is applicable to images captured using a wide-angle lens having image distortion in general, such as an image with a fisheye lens (image in a fisheye format), an image in a dual fisheye format, or the like, in addition to a 360-degree image (image in an equirectangular format or panoramic image).

### Second Example Embodiment

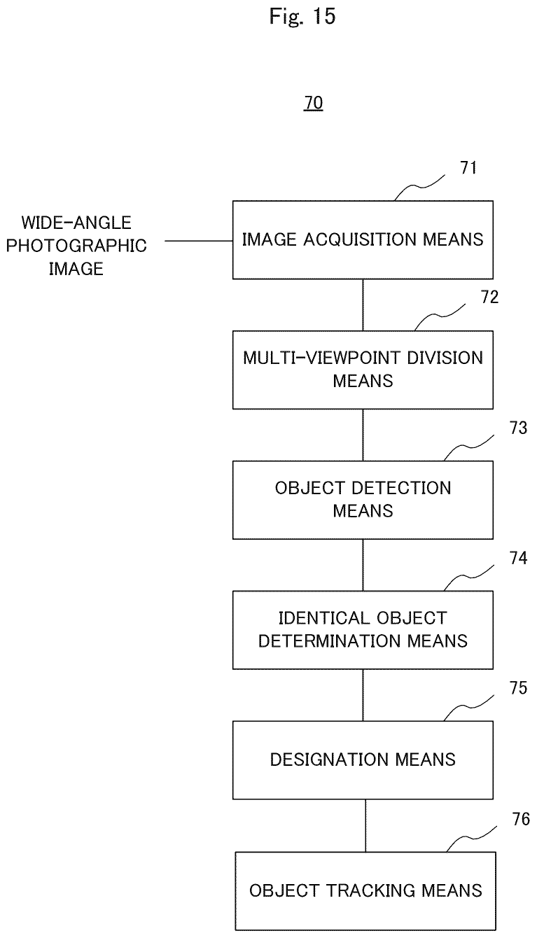

FIG. 15 is a block diagram illustrating a configuration of an object tracking device according to a second example embodiment. An object tracking device 70 according to the second example embodiment includes an image acquisition means 71, a multi-viewpoint division means 72, an object detection means 73, an identical object determination means 74, a designation means 75, and an object tracking means 76.

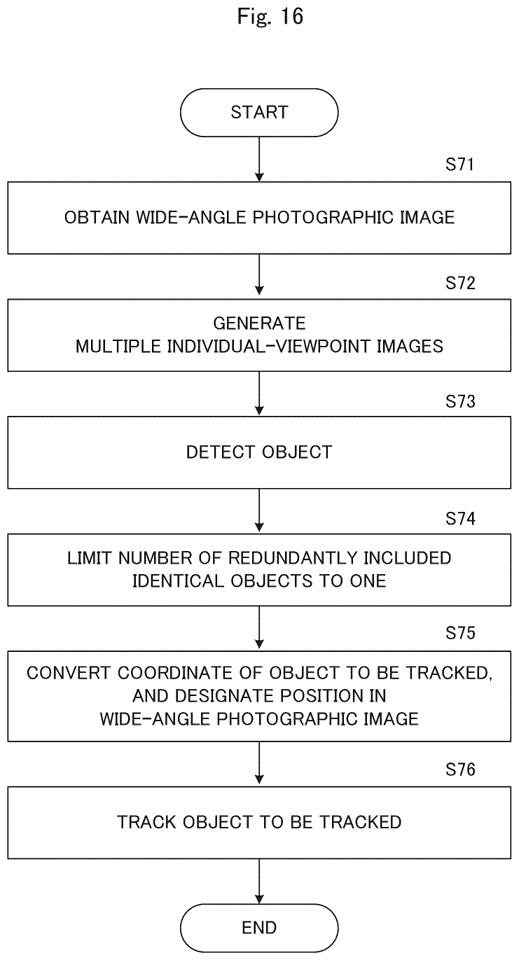

FIG. 16 is a flowchart of a process to be performed by the object tracking device 70 according to the second example embodiment. The image acquisition means 71 obtains a wide-angle photographic image with a wide-angle camera (step S71). The multi-viewpoint division means 72 divides the wide-angle photographic image and corrects distortion, thereby generating a plurality of individual-viewpoint images (step S72). The object detection means 73 detects objects to be tracked from the plurality of individual-viewpoint images (step S73). The identical object determination means 74 limits the number of identical objects redundantly included in the detected objects to be tracked to one (step S74). The designation means 75 converts coordinates of the object to be tracked in the coordinate system of the individual-viewpoint image into coordinates in the coordinate system of the wide-angle photographic image, and designates the converted coordinates as a position of the object to be tracked in the wide-angle photographic image (step S75). The object tracking means 76 tracks the object to be tracked based on the wide-angle photographic image and the designated position of the object to be tracked (step S76).

According to the object tracking device 70 of the second example embodiment, an object may be tracked from an image having distortion, such as an image captured by a wide-angle camera, without the need for training using a dedicated data set.

A part or all of the example embodiments described above may also be described as the following supplementary notes, but not limited thereto.

### Supplementary Note 1

An object tracking device comprising:
an image acquisition means configured to obtain a wide-angle photographic image with a wide-angle camera;
a multi-viewpoint division means configured to divide the wide-angle photographic image, correcting distortion, and generating a plurality of individual-viewpoint images;
an object detection means configured to detect an object to be tracked from the plurality of individual-viewpoint images;
an identical object determination means configured to limit a number of identical objects redundantly included in the detected object to be tracked to one;
a designation means configured to convert a coordinate of the object to be tracked in a coordinate system of the individual-viewpoint images into a coordinate in a coordinate system of the wide-angle photographic image, and designating the converted coordinate as a position of the object to be tracked in the wide-angle photographic image; and
an object tracking means configured to track the object to be tracked based on the wide-angle photographic image and the designated position of the object to be tracked.

### Supplementary Note 2

The object tracking device according to supplementary note 1, wherein
the object tracking means includes:
a distortion correction means configured to preform distortion correction in a predetermined range including the designated position of the object to be tracked in the wide-angle photographic image; and
a tracking means configured to track the object to be tracked using an image obtained by the distortion correction and outputting a tracking result.

### Supplementary Note 3

The object tracking device according to supplementary note 1, wherein the multi-viewpoint division means divides the wide-angle photographic image in such a way that each of the individual-viewpoint images has a portion that overlaps with an adjacent individual-viewpoint image.

### Supplementary Note 4

The object tracking device according to supplementary note 1, wherein the identical object determination means determines a plurality of detected objects as an identical object in a case where a degree of similarity between the plurality of objects is equal to or higher than a predetermined value.

### Supplementary Note 5

The object tracking device according to supplementary note 1, wherein the identical object determination means converts coordinates of a plurality of detected objects in the coordinate system of the individual-viewpoint images into coordinates in the coordinate system of the wide-angle photographic image, and determines the plurality of objects as an identical object in a case where the converted coordinates are closer than a predetermined distance.

### Supplementary Note 6

The object tracking device according to supplementary note 1, wherein the identical object determination means limits the redundantly included identical objects to an object having a maximum rectangular size of the detected object.

### Supplementary Note 7

The object tracking device according to supplementary note 1, wherein the identical object determination means limits the redundantly included identical objects to an object having maximum reliability of the detected object.

### Supplementary Note 8

The object tracking device according to supplementary note 1, wherein the object detection means generates a synthetic image by combining the plurality of individual-viewpoint images, and detects the object from the synthetic image.

### Supplementary Note 9

An object tracking method to be executed by a computer, the method comprising:
obtaining a wide-angle photographic image with a wide-angle camera;
generating a plurality of individual-viewpoint images by dividing the wide-angle photographic image and correcting distortion;
detecting an object to be tracked from the plurality of individual-viewpoint images;
limiting a number of identical objects redundantly included in the detected object to be tracked to one;
converting a coordinate of the object to be tracked in a coordinate system of the individual-viewpoint images into a coordinate in a coordinate system of the wide-angle photographic image, and designating the converted coordinate as a position of the object to be tracked in the wide-angle photographic image; and
tracking the object to be tracked based on the wide-angle photographic image and the designated position of the object to be tracked.

### Supplementary Note 10

A recording medium storing a program, the program causing a computer to perform a process comprising:
obtaining a wide-angle photographic image with a wide-angle camera;
generating a plurality of individual-viewpoint images by dividing the wide-angle photographic image and correcting distortion;
detecting an object to be tracked from the plurality of individual-viewpoint images;
limiting a number of identical objects redundantly included in the detected object to be tracked to one;
converting a coordinate of the object to be tracked in a coordinate system of the individual-viewpoint images into a coordinate in a coordinate system of the wide-angle photographic image, and designating the converted coordinate as a position of the object to be tracked in the wide-angle photographic image; and
tracking the object to be tracked based on the wide-angle photographic image and the designated position of the object to be tracked.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

13 Processor
21 Image acquisition unit
22 Multi-viewpoint division unit
23 Object detection unit
24 Identical object determination unit
25 Tracked object designation unit
26 Distortion correction unit
27 Tracking unit
28 Output unit
100 Object tracking device

What is claimed is:

1. An object tracking device comprising:
at least one memory configured to store instructions; and
at least one processor configured to execute the instructions to:
obtain a wide-angle photographic image with a wide-angle camera;
divide the wide-angle photographic image, correcting distortion, and generating a plurality of individual-viewpoint images;
detect an object to be tracked from the plurality of individual-viewpoint images;
limit a number of identical objects redundantly included in the detected object to be tracked to one;
convert a coordinate of the object to be tracked in a coordinate system of the individual-viewpoint images into a coordinate in a coordinate system of the wide-angle photographic image, and designating the converted coordinate as a position of the object to be tracked in the wide-angle photographic image; and
track the object to be tracked based on the wide-angle photographic image and the designated position of the object to be tracked.

2. The object tracking device according to claim 1, wherein
to track the object, the processor is further configured to
perform distortion correction in a predetermined range including the designated position of the object to be tracked in the wide-angle photographic image; and
track the object to be tracked using an image obtained by the distortion correction and outputting a tracking result.

3. The object tracking device according to claim 1, wherein the processor divides the wide-angle photographic image in such a way that each of the individual-viewpoint images has a portion that overlaps with an adjacent individual-viewpoint image.

4. The object tracking device according to claim 1, wherein the processor determines a plurality of detected objects as an identical object in a case where a degree of similarity between the plurality of objects is equal to or higher than a predetermined value.

5. The object tracking device according to claim 1, wherein the processor converts coordinates of a plurality of detected objects in the coordinate system of the individual-viewpoint images into coordinates in the coordinate system of the wide-angle photographic image, and determines the plurality of objects as an identical object in a case where the converted coordinates are closer than a predetermined distance.

6. The object tracking device according to claim 1, wherein the processor limits the redundantly included identical objects to an object having a maximum rectangular size of the detected object.

7. The object tracking device according to claim 1, wherein the processor limits the redundantly included identical objects to an object having maximum reliability of the detected object.

8. The object tracking device according to claim 1, wherein the processor generates a synthetic image by combining the plurality of individual-viewpoint images, and detects the object from the synthetic image.

9. An object tracking method to be executed by a computer, the method comprising:
obtaining a wide-angle photographic image with a wide-angle camera;
generating a plurality of individual-viewpoint images by dividing the wide-angle photographic image and correcting distortion;
detecting an object to be tracked from the plurality of individual-viewpoint images;
limiting a number of identical objects redundantly included in the detected object to be tracked to one;
converting a coordinate of the object to be tracked in a coordinate system of the individual-viewpoint images into a coordinate in a coordinate system of the wide-angle photographic image, and designating the converted coordinate as a position of the object to be tracked in the wide-angle photographic image; and
tracking the object to be tracked based on the wide-angle photographic image and the designated position of the object to be tracked.

10. A non-transitory computer readable recording medium storing a program, the program causing a computer to perform a process comprising:
obtaining a wide-angle photographic image with a wide-angle camera;
generating a plurality of individual-viewpoint images by dividing the wide-angle photographic image and correcting distortion;
detecting an object to be tracked from the plurality of individual-viewpoint images;
limiting a number of identical objects redundantly included in the detected object to be tracked to one;
converting a coordinate of the object to be tracked in a coordinate system of the individual-viewpoint images into a coordinate in a coordinate system of the wide-angle photographic image, and designating the converted coordinate as a position of the object to be tracked in the wide-angle photographic image; and
tracking the object to be tracked based on the wide-angle photographic image and the designated position of the object to be tracked.
